(19) United States
(12) Patent Application Publication
(10) Pub. No.: US 2010/0148903 A1
(43) Pub. Date: Jun. 17, 2010

(54) ELECTRICAL ENERGY TRANSFORMATION APPARATUS

(75) Inventors: Weijun Yin, Niskayuna, NY (US); Wendy Wen-Ling Lin, Niskayuna, NY (US); Sergei Kniajanski, Clifton Park, NY (US); Xiaolan Wei, Clifton Park, NY (US); Denis Perrillat-Amede, Paris (FR); Jason Stuart Katcha, Whitefish Bay, WI (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/333,601

(22) Filed: Dec. 12, 2008

(51) Int. Cl. H01F 27/02; B01J 31/12

(52) U.S. Cl. 336/90

(57) ABSTRACT

In one aspect, the present invention provides a high voltage-high frequency electrical energy transformation apparatus comprising a frequency inverter capable of converting 60 Hz electrical energy into 40-100 KHz electrical energy; and a voltage transformer. The voltage transformer comprises a transformer housing; at least one soft magnetic core; a low voltage primary winding and a high voltage secondary winding; and a solid insulating material comprising polydicyclopentadiene. The solid insulating material is in contact with the high voltage secondary winding.

### BACKGROUND

The invention relates to a high voltage-high frequency electrical energy transformation apparatus comprising a voltage transformer. Further, the present disclosure relates to a solid insulating material comprising polydicyclopentadiene for the voltage transformer. In addition, the present disclosure relates to a method of making the solid insulating material comprising polydicyclopentadiene.

A typical transformer has a primary winding magnetically coupled to a secondary winding. The magnetic coupling is usually accomplished with one or more magnetic cores about which the primary and secondary are wound. In a so-called “ideal” transformer (that is, one which neither stores nor dissipates energy, has unity coupling coefficients, and has pure inductances of infinite value), current flowing in the primary induces a current flow in the secondary that is equal to the current in the primary times the ratio of the number of turns of the primary to the number of turns of the secondary. In real, non-ideal transformers, losses arise from factors such as winding resistances, magnetic flux changes, unequal magnetic flux sharing between the primary and secondary, eddy currents, loads coupled in circuit with the secondary, and other factors. Thus as a cumulative result of all these factors, that the current flowing in the secondary is not related to the current flowing in the primary by the turns ratio.

In a high voltage transformer, a primary voltage of several tens of volts is transformed into a secondary voltage of several hundreds to several Kilovolts (typically: 0.6-2 kV). A high voltage high frequency transformer would need to fulfill the following important requirements such as high insulation voltage, i.e. high partial discharge, free operation voltage, low dielectric loss to minimize the dielectric heating generated loss at high voltage, therefore low thermal runaway induced failure.

In addition, the insulation would need to have hot oil stability and compatibility. The high voltage insulation material would need to prevent the dielectric loss that would be significant at high voltages. In general, low loss dielectric materials such as silk wrap, fluoropolymer coated winding wire, polypropylene sheets, or Kraft paper and mineral oil were employed as insulation material. Furthermore, to minimise distortion of the pulse shape, a transformer needs to have low values of leakage inductance and distributed capacitance, and a high open-circuit inductance. In power-type pulse transformers, a low coupling capacitance (between the primary and secondary) is required to protect the circuitry on the primary side from high-powered transients created by the load. Thus, high insulation resistance and high breakdown voltage are required. Although polypropylene has high insulation resistance and high breakdown voltage, it can not be used at temperature above 80° C. due to large amount of swelling resulting in change in the dimension of the material.

Poly(dicyclopentadiene) (PDCPD) is a polyolefinic thermoset material known for its mechanical properties, wide temperature application range, its flexibility for various reaction injection moldings due to extremely low viscosity of the monomer. PDCPD is made of dicyclopentadiene (DCPD), which is a part of oil refinery C5 fraction. DCPD is produced by a variety of oil refinery companies in megaton scale in different grades: from 80% to >98%. The impurities in DCPD are mostly cyclopentadiene (CPD) and oligocyclopentadienes(tricyclopentadiene, tetracyclopentadiene and higher oligomers). DCPD is a solid with melting point of 32-33° C. The presence of olygocyclopentadienes reduces the mixture melting point to below 0° C.

Metathesis polymerization reactions (for example, ring opening metathesis polymerization of cycloolefins) can provide for synthesis of polycycloolefins like poly(dicyclopentadiene). Polydicyclopentadiene synthesized by ring opening metathesis polymerization can be reinforced with reinforcing materials (for example, fibers) to provide composites for high performance applications. The polydicyclopentadiene as a material has good properties such as dielectric strength, thermal stability, mechanical strength and chemical resistance. These properties are however sensitive to many factors such as the monomer quality (cyclopentadiene-dicyclopentadiene-oligocyclopentadienes composition), catalyst type and catalyst amount, polymerization temperature, reaction vessel material and its geometry, the presence of inorganic fillers, etc.

Therefore, there is a need for further improvements to high voltage-high frequency electrical energy transformation apparatus that exceed the capabilities of traditional systems comprising polypropylene or Kraft paper in oil as insulating materials. The present invention provides high voltage-high frequency electrical energy transformation apparatus having an excellent balance of properties based upon its unique component insulating materials.

### BRIEF DESCRIPTION OF THE DRAWINGS

FIG. 1 Represents an electrical energy transformation apparatus in accordance with an embodiment of the invention.

FIG. 2 Represents an electrical energy transformation apparatus in accordance with an embodiment of the invention.

FIG. 3 Represents an electrical energy transformation apparatus in accordance with an embodiment of the invention.

FIG. 4 Represents an electrical energy transformation apparatus in accordance with an embodiment of the invention.

FIG. 5 Represents an electrical energy transformation apparatus in accordance with an embodiment of the invention.

### BRIEF DESCRIPTION

In one aspect, the present invention provides a high voltage-high frequency electrical energy transformation apparatus comprising a frequency inverter capable of converting 60 Hz electrical energy into 40-100 KHz electrical energy; and a voltage transformer. The voltage transformer comprises a transformer housing; at least one soft magnetic core; a low voltage primary winding and a high voltage secondary winding; and a solid insulating material comprising polydicyclopentadiene. The solid insulating material is in contact with the high voltage secondary winding.

In another aspect, the present invention provides a high voltage-high frequency electrical energy transformation apparatus comprising a an IGBT based high frequency inverter capable of converting 60 Hz electrical energy into 40-100 KHz electrical energy; and a voltage transformer. The voltage transformer comprising a transformer housing; at least one soft magnet core comprising a ferrite material; a low voltage primary winding; a high voltage secondary winding comprising a copper conductor; and a solid insulating material comprising polydicyclopentadiene and wherein the solid insulating material is in contact with the high voltage secondary winding is provided.

In yet another aspect, the present invention provides a CT scanner comprising a high voltage-high frequency electrical energy transformation apparatus. The apparatus comprising a frequency inverter capable of converting 60 Hz electrical energy into 40-600 KHz electrical energy; and a voltage transformer. The voltage transformer comprising an oil-filled transformer housing; at least one soft magnet core comprising a ferrite material; a low voltage primary winding; a high voltage secondary winding; and a solid insulating material comprising polydicyclopentadiene and wherein the solid insulating material is in contact with the high voltage secondary winding is provided.

These and other features, aspects, and advantages of the present invention may be understood more readily by reference to the following detailed description.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein, the term “solvent” can refer to a single solvent or a mixture of solvents.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical, which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂₎₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph—), 4-(3-bromoprop-1-yl)phen-1-yl (i.e., 4-BrCH₂CH₂CH₂Ph—), and the like. Further examples of aromatic radicals include 4-allyloxyphen-1-oxy, 4-aminophen-1-yl (i.e., 4-H₂NPh—), 3-aminocarbonylphen-1-yl (i.e., NH₂COPh—), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph—), 4-mercaptomethylphen-1-yl (i.e., 4-HSCH₂Ph—), 4-methylthiophen-1-yl (i.e., 4-CH₃SPh—), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl(C₃H₂N2—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more monocyclic components. For example, a cyclohexylmethyl group (C₆H₁₁CH₂—) is a cycloaliphatic radical, which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis(cyclohex-4-yl) (i.e., —C₆H₁₀C(CF₃)₂C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C₆H₁₀-), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2—CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms, which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH2—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl ( i.e., (CH₃)₃Si—), t-butyldimethylsilyl, 3-trimethyoxysilylpropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

As used herein the term “Cyclopentadiene dimer” refers to bis(cyclopentadiene); 4,7-methanoindene, 3a,4,7,7a-tetrahydro-; bicyclopentadiene; DCPD; dicyclopentadiene; dimer cyclopentadiene; tetracyclo-[5.2.1.02,6]decane; 1,3-cyclopentadiene, dimer; 3a,4,7,7a-tetrahydro-4,7-methano-1H-indene; tricyclo[5.2.1.02,6]deca-3,8-diene; 4,7-methylene-4,7,8,9-tetrahydroindene; 3a,4,7,7a-tetrahydro-4,7-methanoindene.

As noted, in one embodiment the present invention provides a high voltage-high frequency electrical energy transformation apparatus comprising: (a) a frequency inverter capable of converting 60 Hz electrical energy into 40-100 kHz electrical energy; and (b) a voltage transformer. The voltage transformer comprises a transformer housing; at least one soft magnet core; a low voltage primary winding; a high voltage secondary winding; and a solid insulating material comprising polydicyclopentadiene. In one embodiment, the solid insulating material is in contact with the high voltage secondary winding.

In one embodiment, the frequency inverter is capable of converting electrical energy in a range from 50 Hz to about 80 Hz into electrical energy in a range from about 20 kHz to about 50 kHz. In another embodiment, the frequency inverter is capable of converting electrical energy of about 50-60 Hz into electrical energy in a range from about 60 kHz to about 200 kHz. In one embodiment, the inverter is selected from a resonant inverter, a non-resonant inverter, power inverter, IGBT pulse width modulated inverter. In another embodiment, the inverter is a series super resonant inverter.

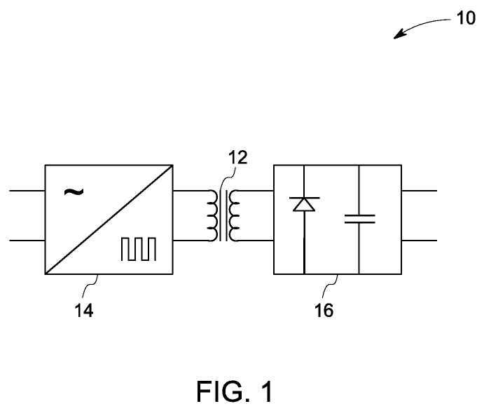

In one embodiment the high voltage-high frequency electrical energy transformation apparatus comprises a voltage transformer. In one embodiment, as shown in FIG. 1, the electrical energy transformation apparatus (10) includes a transformer (12) is in contact with an inverter (14) and a rectifier (16). The voltage transformer comprises a transformer housing, at least one soft magnet core, a low voltage primary winding and a high voltage secondary winding.

In one embodiment, the soft magnet core comprises at least one ferromagnetic material or ferrimagnetic material. Non-limiting examples of soft magnet core materials is at least one selected from iron, MnZn, NiZn, NiFe, CoSiO₂. In yet another embodiment, the soft magnet core is a soft iron core.

In one embodiment, the transformer comprises two windings, which may convert one AC voltage to another AC voltage. In one embodiment, the AC current in the primary winding can create an alternating magnetic field in the magnetic core just as it would in an electromagnet, and a secondary winding can wrap about the same core and the magnetic field in the core may create current. The voltage in the secondary winding can be controlled by the ratio of the number of turns in the two windings. For example, if the primary and secondary windings have the same number of turns, the primary and secondary voltage would be the same. Also by way of example, if the secondary winding has half as many turns as the primary winding, then the voltage in the secondary winding may be half that of the voltage in the primary winding. In one embodiment, the transformer turns ratio is selected to eliminate mismatch or match impedances as closely as possible.

In one embodiment, the primary winding of the voltage transformer is connected to an inverter, the inverter is being fed by a rectifier. The output of the secondary winding of the transformer is connected to a rectifier. In another embodiment, the primary and secondary windings can be constructed as concentric rings. In another embodiment, the transformer core is also constructed as a shell-like core enclosing the windings and consisting of the soft magnet core. In one embodiment, the secondary winding and the soft magnet core are arranged in a closed, hollow ring-shaped housing which can also receive additional high voltage components, e.g. rectifiers, capacitors and possibly even an X-ray tube.

In one embodiment, the secondary winding system consists of n secondary windings electrically separated from the primary winding. The secondary windings are insulated by contacting the secondary windings with a solid insulating material comprising polydicyclopentadiene.

In one embodiment, the solid insulating material comprises a polymerizable formulation comprising dicyclopentadiene. In another embodiment, the solid insulating material comprises a polymerizable formulation comprising cyclopentadiene dimer, and cyclopentadiene oligomers. In one embodiment, the cyclopentadiene dimer has structure I.

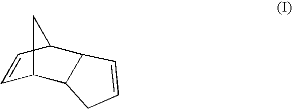

In one embodiment, the polymerizable formulation includes cyclopentadiene oligomers. As used herein the term “oligomer” refers to trimers, tetramers, petamers, hexamers and optionally septamers and octamers and the like. The term cyclopentadiene oligomer refers to a substance containing structural units derived from cyclopentadiene having a higher molecular weight than cyclopentadiene dimer. Cyclopentadiene oligomer may be formed by a sequential addition of 1 or more cyclopentadiene molecules to cyclopentadiene dimer via Diels-Alder addition reaction.

In one embodiment, the solid insulating material comprising polydicyclopentadiene is a cured resin. As used herein a “curable resin” refers to a material having one or more reactive groups that may participate in a chemical reaction when exposed to one or more of thermal energy, electromagnetic radiation, or chemical reagents. Curing as used herein refers to a reaction resulting in polymerization, cross-linking, or both polymerization and cross-linking of a curable material (for example, dicyclopentadiene) having one or more reactive groups (for example, metathesis-active bonds in the cycloolefin).

In one embodiment, the cyclopentdiene oligomer is present in an amount from about 5% to 25% based on the amount of cyclopentadiene dimer and cyclopentadiene oligomers present in the formulation. In another embodiment, the cyclopentdiene oligomer is present in an amount from about 8% to about 20% based on the amount of cyclopentadiene dimer and cyclopentadiene oligomers present in the formulation. In yet another embodiment, the cyclopentdiene oligomer is present in an amount from about 10% to about 15% based on the amount of cyclopentadiene dimer and cyclopentadiene oligomers present in the formulation.

In one embodiment, the polydicyclopentadiene is prepared by ring opening metathesis polymerization in the presence of a ring opening metathesis (ROMP) catalyst. The metathesis catalyst catalyzes a ring-opening metathesis polymerization reaction when contacted with the cyclopentadiene dimer under suitable conditions. Reaction conditions suitable for effecting the ring-opening metathesis polymerization of the polymerizable formulations provided by the present invention are illustrated in the experimental section of this disclosure. Generally, however, the polymerizable formulations provided by the present invention may be preserved in a latent state by judicious selection of storage temperature. Typically, the ring-opening metathesis polymerization is effected by warming the polymerizable formulation. An advantage of the polymerizable formulations provided by the present invention is that they are free flowing liquids at relatively low temperature and may be thoroughly contacted with a filler prior to polymerization. In one embodiment, the polymerizable formulation provided by the present invention further comprises a second cycloolefin, for example, cyclooctene. Suitable ring opening metathesis catalysts include organometalic compounds having structure (II):

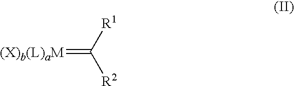

wherein “a” and “b” are independently integers from 1 to 3, wherein “a+b” is less than or equal to 5; M is vanadium, ruthenium, osmium, titanium, tungsten, rhenium, iridium, or molybdenum; X is independently at each occurrence an anionic ligand; L is independently at each occurrence a neutral electron donor ligand; R¹ is hydrogen, a C₁-C₂₀ aliphatic radical, a C₃-C₂₀ cycloaliphatic radical, a C₃-C₂₀ aromatic radical; and R² is C₁-C₂₀ aliphatic radical, a C₃-C₂₀ cycloaliphatic radical, a C₃-C₂₀ aromatic radical or at least one of L, R¹ or R² fused to form a cyclic group.

TABLE 1
Examples Of Ring Opening Metathesis Catalyst Having Structure II

| | | |
|---|---|---|
| 1a | 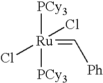 | M = Ru, X = Cl, L = P(p-cymene)₃, R¹ = H, R² = phenyl, “a” = 2, “b” = 2 |
| 1b | 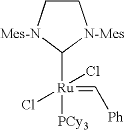 | M = Ru, X = Cl, L = P(p-cymene)₃, 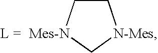 Mes = N,N′- bis(mesityl)imidazol-2-ylidene, R¹ = H, R² = phenyl, “a” = 2, “b” = 2 |
| 1c | 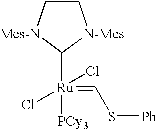 | M = Ru, X = Cl, L = P(p-cymene)₃, 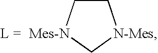 R¹ = H, R² = S-Ph, “a” = 2, “b” = 2 |
| 1d | 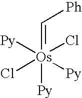 | M = Os, X = Cl, L = pyridine, R¹ = H, R² = phenyl, “a” = 3, “b” = 2 |
| 1e | 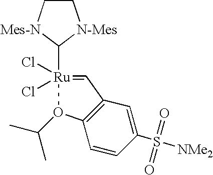 | M = Ru, X = Cl, L = O(Ph)iso-Pr, L = N,N′-bis(mesityl)imidazol-2- ylidene, R¹ = H, R² = (1-dimethylamidosulfoxy,-4- isopropyloxy)phen-5-yl, “a” = 2, “b” = 2 |
| 1f | 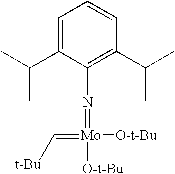 | M = Mo, X = O-tBu, 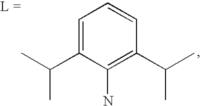 R¹ = H, R² = t-Bu, “a” = 1, “b” = 2 |

In one embodiment, M is ruthenium or osmium. In one embodiment, ruthenium or osmium can form a metal center of the catalyst. In one embodiment, Ru or Os in the catalyst can be in the +2 oxidation state, can have an electron count of 16, and can be penta-coordinated. In an alternate embodiment, Ru or Os in the catalyst can be in the +2 oxidation state, can have an electron count of 18, and can be hexa-coordinated. A titanium-based ROMP catalyst can be used in some embodiments, possibly in addition to the Ru or Os based catalysts.

An anionic ligand X in structure (II) can be a unidentate ligand or bidentate ligand. In one embodiment, X is independently at each occurrence a halide, a carboxylate group, a sulfonate group, a sulfinate group, a diketonate, an alkoxide, an aryloxide, a cyclopentadienide group, a cyanide group, a cyanate group, or a thiocyanate group. In one embodiment, X is independently at each occurrence chloride, fluoride, bromide, iodide, CF₃CO₂, —CH₃CO₂, —CFH₂CO₂, —(CH₃)₃CO , —(CF₃)₂(CH₃)CO, —(CF₃)(CH₃)₂CO, —PhO, —MeO, —EtO, tosylate, mesylate, or trifluoromethanesulfonate.

In certain embodiments of the present invention, the ring opening metathesis catalyst has structure II and the number of anionic ligands X bonded to the metal center can depend on one or more of the coordination state of the transition metal (for example, penta-coordinated or hexa-coordinated), the number of neutral electron donating ligands “L” bonded to the transition metal, and the number of coordinating groups present in the ligand. At times herein, the number of coordinating groups present in a ligand “L” or “X” is referred to as the “dentency” of that ligand. For example a monodenate ligand has a dentency of 1, whereas a bidentae ligand has a dentency of 2. In one embodiment, X is a unidentate anionic ligand and “b” is 2. In another embodiment, X is a bidentate anionic ligand and “b” is 1. In yet another embodiment, X is independently at each occurrence a chloride or a bromide and “b’ is 2.

As noted, an electron donor ligand L present in a suitable ring opening polymerization catalyst having structure II is a neutral electron donor ligand, which may be monodentate, bidentate, or tridentate. Suitable neutral electron donor ligands include phosphines, phosphine oxides, arsines, stibines, ethers, esters, amines, amides, imines, sulfoxides, nitrosyl compounds, and sulfides. In one embodiment, at least one L is a phosphine having structure P(R³R⁴R⁵), wherein R³, R⁴, and R⁵ are each independently an aliphatic radical, a cycloaliphatic radical, or an aromatic radical. In one embodiment, at least L can include P(cyclohexyl)₃, P(cyclopentyl)₃, P(isopropyl)₃, or P(phenyl)₃. In one embodiment, the ring opening polymerization catalyst has structure II and comprises at least one triarylphosphine, for example triphenyl phosphine.

In one embodiment, the ring opening polymerization catalyst has structure II at least one L is a heterocyclic ligand. A heterocyclic ligand refers to an array of atoms forming a ring structure and including one or more heteroatoms as part of the ring, where heteroatoms are as defined hereinabove. A heterocyclic ligand can be aromatic (heteroarene ligand) or non-aromatic, wherein a non-aromatic heterocyclic ligand can be saturated or unsaturated. A heterocyclic ligand can be further fused to one or more cyclic ligand, which can be a heterocycle or a cyclic hydrocarbon, for example in indole.

In one embodiment, the ring opening polymerization catalyst has structure II and comprises at least one heteroarene ligand “L”. A heteroarene ligand refers to an unsaturated heterocyclic ligand in which the double bonds form an aromatic system. In one embodiment, at least one L is furan, thiophene, pyrrole, pyridine, bipyridine, picolylimine, gamma-pyran, gamma-thiopyran, phenanthroline, pyrimidine, bipyrimidine, pyrazine, indole, coumarone, thionaphthene, carbazole, dibenzofuran, dibenzothiophene, pyrazole, imidazole, benzimidazole, oxazole, thiazole, dithiazole, isoxazole, isothiazole, quinoline, bisquinoline, isoquinoline, bisisoquinoline, acridine, chromene, phenazine, phenoxazine, phenothiazine, triazine, thianthrene, purine, bisimidazole, bisoxazole or phosphine such as for example P(cyclohexyl)₃, P(cyclopentyl)₃, P(isopropyl)₃, or P(phenyl)₃. In one embodiment, at least one L is a monodentate heteroarene ligand, which can be unsubstituted or substituted, for example, pyridine. In one embodiment at least one L is a bidentate heteroarene ligand, which can be substituted or unsubstituted, for example, bipyridine, phenanthroline, bithiazole, bipyrimidine, or picolylimine.

In one embodiment, L is a N-heterocyclic carbene ligand (NHC), as is shown for example in Entry 1f of Table 1 herein. A N-heterocyclic carbene ligand is a heterocyclic ligand including at least one N atom in the ring and a carbon atom having a free electron pair. Non-limiting examples of N-heterocyclic carbene ligand include 1,3-dimesitylimidazolidin -2-ylidene; 1,3-di(1-adamantyl)imidazolidin -2-ylidene; 1-cyclohexyl -3-mesitylimidazolidin -2-ylidene; 1,3-dimesityl octahydro benzimidazol -2-ylidene; 1,3-diisopropyl -4-imidazolin -2-ylidene; 1,3-di(1-phenylethyl)-4-imidazolin-2-ylidene; 1,3-dimesityl-2,3-dihydrobenzimidazol-2-ylidene; 1,3,4-triphenyl-2,3,4,5-tetrahydro-1H-1,2,4-triazol-5-ylidene; 1,3-dicyclohexylhexahydro pyrimidin-2-ylidene; N,N,N′,N′-tetraisopropyl formamidinylidene; 1,3,4-triphenyl-4,5-dihydro-1H-1,2,4-triazol-5-ylidene; or 3-(2,6-diisopropylphenyl)-2,3-dihydrothiazol-2-ylidene.

The number of neutral electron donor ligands L bonded to the transition metal depends on one or more of the coordination state of the transition metal (for example, penta-coordinated or hexa-coordinated), the number of anionic ligands bonded to the transition metal, or dentency of the neutral electron donor ligand. In one embodiment, “a” is 1. In one embodiment, “a” is 2. In one embodiment, “a” is 3. In one embodiment, R³, R⁴, X and L can be bound to one another to form a multidentate ligand. In one embodiment two or more of R³, R⁴, X or L can independently form a cyclic ring, for example, R³ and R⁴ can together form a substituted or unsubstituted indene group.

In one embodiment, the ring opening metathesis catalyst has structure III

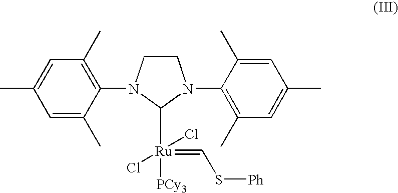

In another embodiment, the ring opening metathesis catalyst is selected from the catalyst having structure IV and the catalyst having structure V.

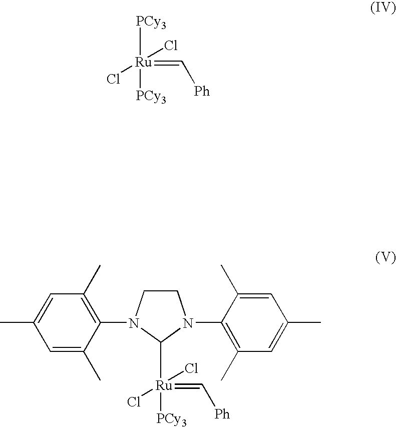

In yet another embodiment, the ring opening metathesis catalyst has structure VI.

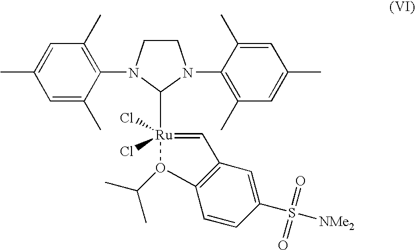

In another embodiment, the ring opening metathesis catalyst has a structure V.

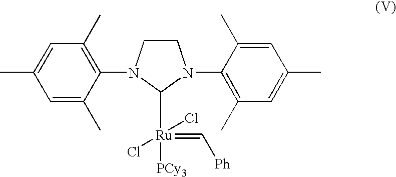

In one embodiment, the catalyst comprises bis(tricyclohexylphosphine)benzylidine ruthenium (IV) chloride (CAS No. 172222-30-9), 1,3-Bis(2,4,6-trimethylphenyl)-2-imidazolidinylidene)dichloro(phenylmethylene) (tricyclohexylphosphine)ruthenium (CAS No. 246047-72-3), 1,3-Bis(2,4,6-trimethylphenyl)-2-imidazolidinylidene)dichloro(phenylmethylene) (di-3-bromopyridine)ruthenium, or 1,3-Bis-(2,4,6-trimethylphenyl)-2-imidazolidinylidene)dichloro(o-isopropoxyphenyl methylene)ruthenium (CAS No. 301224-40-8).

The metathesis catalyst can be present in an amount greater than about 0.0015 weight percent based on the amount of cyclopentadiene dimer and cyclopentadiene oligomers. In one embodiment, the metathesis catalyst can be present in an amount in a range of from about 0.01 weight percent to about 0.05 weight percent based on the amount of cyclopentadiene dimer and cyclopentadiene oligomers. In yet another embodiment, the metathesis catalyst can be present in an amount in a range of from about 0.015 weight percent to about 0.025 weight percent based on the amount of cyclopentadiene dimer and cyclopentadiene oligomers.

In one embodiment, the solid insulating material includes an inorganic filler. Suitable fillers are illustrated by siliceous materials, carbonaceous materials, metal hydrates, metal oxides, metal borides, metal nitrides, and mixtures of two or more of the foregoing. In one embodiment, the filler is a siliceous material. The filler may be particulates, fibers, platelets, whiskers, rods, or a combination of two or more of the foregoing. In one embodiment, the filler includes a plurality of particles having an average particle size, particle size distribution, average particle surface area, particle shape, and particle cross-sectional geometry.

In one embodiment, the inorganic filler is a surface modified nanoparticulate silica. In one embodiment, the surface modified nanoparticulate silica comprises nanoparticulate silica reacted with an organic moiety that is compatible with the cyclopentadiene dimer and cyclopentadiene oligomers. The resulting surface modified nanoparticulate silica particles are dispersible in organic solvents such as hexanes, and are dispersible in the polymerizable formulation. Exemplary surface functionalizing or modifying agents include but are not limited to silane compounds and silazane compounds, with specific examples including 3-glycidoxypropyl trimethoxysilane (GPMS), 3-methoxypropyl trimethoxysilane (MPMS), acetoxymethyl trimethoxysilane (AMMS), methyl trimethoxysilame (MMS), hexamethyldisilazane (HMDZ), and combinations thereof. For example 3-glycidoxypropyl trimethoxysilane (GPMS) can be reacted with the hydroxyl functional groups at the surface of a silicon particle (silanol groups) to form glycidoxypropyl functionalized silica.

Examples of silanes containing organofunctional groups include n-(2-aminoethyl)-3-aminopropyltriethoxysilane, n-(2-aminoethyl)-3-aminopropyltrimethoxy silane, 3-aminopropyltrimethoxysilane, 3-aminopropyltriethoxysilane, methacryloxypropyltrimethoxysilane, methacryloxymethyltriethoxysilane, acetoxyethyltrimethoxysilane, (3-acryl-oxypropyl)trimethoxysilane, 5,6-epoxyhexyltriethoxysilane, (3-glycidoxypropyl)triethoxy silane, (3-glycidoxypropyl)trimethoxysilane, 3-mercaptopropyltrimethoxysilane, 3-mercaptopropyltriethoxysilane, 2-cyanoethyltrimethoxysilane, vinyltrimethoxysilane, vinyltriethoxysilane, allyltriethoxysilane, and n-(3-acryloxy-2-hydroxypropyl)-3-aminopropyltriethoxysilane. In one embodiment, the nanoparticulate silica is functionalized with trimethylsilyl group, aminosilane group, vinyldimethyl silane group and combinations thereof.

In one embodiment, the solid insulating material contains surface modified nanoparticulate silica particles having a particle size distribution in the range from about 10 nanometer to about 250 nanometers. The surface modification treatment does not add appreciably to the dimensions or diameter of the nanoparticulate silica, such that the particles have substantially the same size both before and after the surface modification treatment.

In one embodiment, the nanoparticulate silica is present in an amount corresponding to from about 0.0001 weight percent to about 25 weight percent based on the total weight of the solid insulating material. In another embodiment, the nanoparticulate silica is present in an amount corresponding to from about 1 weight percent to about 20 weight percent based on the total weight of the solid insulating material. In yet another embodiment, the nanoparticulate silica is present corresponding to from about 2 weight percent to about 18 weight percent based on the total weight of the solid insulating material.

In one embodiment, the solid insulating material comprising polydicyclopentadiene comprises a reaction control agent. Suitable reaction control agents can be one or more of phosphines, sulfonated phosphines, phosphites, phosphinites, or phosphonites. Other suitable reaction control agents may include one or more of arsines, stibines, sulfoxides, carboxyls, ethers, thioethers, or thiophenes. Suitable reaction control agents can include one or more of amines, amides, nitrosyls, pyridines, nitrites, or furans. In one embodiment, an electron donor or a Lewis base can include one or more functional groups, such as hydroxyl, thiol, ketone, aldehyde, ester, ether, amine, amide, nitro acid, carboxylic acid, disulfide, carbonate, carboalkoxy acid, isocyanate, carbodiimide, carboalkoxy, and halogen. In one embodiment, a reaction control agent comprises one or more of triphenylphosphine, tricyclopentylphosphine, tricyclohexylphosphine, triphenylphosphite, pyridine, propylamine, tributylphosphine, benzonitrile, triphenylarsine, anhydrous acetonitrile, thiophene, or furan. In one embodiment, a reaction control agent is one or more of P(cyclohexyl)₃, P(cyclopentyl)₃, P(isopropyl)₃, P(Phenyl)₃, or pyridine. In another embodiment, the reaction control agent is a triphenylphosphine. In yet another embodiment, the reaction control agent is a triphenylphosphite.

In one embodiment, the reaction control agent is present in an amount corresponding to from about 0.05 weight percent to about 2.5 weight percent based on the total weight of the solid insulating material. In another embodiment, the reaction control agent is present in an amount from about 0.25 weight percent to about 1 weight percent based on the total weight of the solid insulating material.

In another embodiment, the solid insulating material further comprises a mineral oil. In one embodiment, the mineral oil is present in an amount corresponding to from about 0.25 weight percent to about 15 weight percent based on the total weight of the solid insulating material. In another embodiment, the mineral oil is present in an amount from about 1.5 weight percent to about 3 weight percent based on the total weight of the solid insulating material.

In one embodiment, the polymerizable formulation comprising dicyclopentadiene has a freezing point of about 0° C. in the absence of an inorganic filler. In another embodiment, the polymerizable formulation comprising dicyclopentadiene has a freezing point of about 5° C. in the absence of an inorganic filler.

In one embodiment, the polymerizable formulation further includes a second cycloolefin monomer. In one embodiment, the second cycloolefin monomer is one or more of norbornene; di(methyl)dicyclopentadiene; dilhydrodicyclopentadiene; tetracyclododecene; ethylidenenorborniene; methyltetracyclododecene; methylnorbornene; ethylnorbornene; dimethylnorbornene; norbornadiene; cyclopentene; cycloheptene; cyclooctene; 7-oxanorbornene; 7-oxabicyclo(2.2.1)hept-5-ene derivatives; 7-oxanorbornadiene; cyclododecene; 2-norbornene (also named bicyclo(2.2.1)-2-heptene); 5-methyl-2-norbornene; 5,6-dimethyl-2-norbornene; 5-ethyl-2-norbornene; 5-butyl-2-norbornene; 5-hexyl-2-norbornene; 5-dodecyl-2-norbornene; 5-isobutyl-2-norbornene; 5-octadecyl-2-norbornene; 5-isopropyl-2-norbornene; 5-phenyl-2-norbornene; 5-p-toluyl-2-norbornene; 5-a-naphthyl-2-norbornene; 5-cyclohexyl-2-norbornene; 5,5-dimethyl-2-norbornene; dicyclopentadiene (or cyclopentadiene dimer); dihydrodicyclopentadiene (or cyclopentene cyclopentadiene codimer); methyl-cyclopentadiene dimer; ethyl cyclopentadiene dimer; tetracyclododecene (also named 1,2,3,4,4a,5,8,8a-octahydro-1,4:5,8-dimethyanonaphthalene); 9-methyl-tetracyclo(6.2.1.1^{3,6}.0^{2,7})-4-dodecene (also named 1,2,3,4,4a,5,8,8a-octahydro-2-methyl-4,4:5,8-dimethanonaphthalene); 9-ethyl tetracyclo(6.2.1.1^{3,6}.0^{2,7})-4-dodecene; 9-propyl-tetracyclo(6.2.1.1^{3,6}.0^{2,7)}-4-dodecene; 9-hexyl tetracyclo(6.2.1.1^{3,6}.0^{2,7})-4-dodecene; 9-decyl tetracyclo (6.2.1.1^{3,6}.0^{2,7})-4-dodecene; 9,10-dimethyl tetracyclo(6.2.1.1^{3,6}.0^{2,7})-4-dodecene; 9-ethlyl-10-methyl tetracyclo(6.2.1.1^{3,6}.0^{2,7})-4-dodecene; 9-cyclohexyl tetracyclo (6.2.1.1^{3,6}.0^{2,7})-4-dodecene; 9-chloro tetracyclo(6.2.1.1^{3,6}.0^{2,7})-4-dodecene; 9-bromo tetracyclo(6.2.1.1^{3,6}.0^{2,7})-4-dodecene; cyclopentadiene-trimer; methyl-cyclopentadiene-trimer; or derivatives of the foregoing. The second cycloolefin monomer can include one or more functional groups either as substituents of the cycloolefin or incorporated into the ring structure of the cycloolefin. In one embodiment, a second cycloolefin monomer is a monocycloolefin. In one embodiment, the second cycloolefin monomer can copolymerize with the cyclopentadiene dimer and/or the cyclopentadiene oligomer when contacted with the methathesis catalyst.

The solid insulating material comprising the polymerizable formulation may include two or more of the aforementioned cycloolefins. In one embodiment, the insulating material comprising the polymerizable formulation may include mixtures of cycloolefins chosen to provide the desired end-use properties or other advantage, for example controlling the melting point of the polymerizable formulation, as well as thermal, mechanical and chemical properties of the polymer produced from the polymerizable formulation. In one embodiment, one or more functional properties of a polymeric material produced using the mixtures of cycloolefins may be determined by the type of functional groups present and the number of functional groups present.

Optionally, the solid insulating material comprising polydicyclopentadiene can include one or more additives selected with reference to performance requirements for particular applications. For example, the additive can be one or more of a fire retardant additive, an antioxidant, a reinforcing filler, modifiers, carrier solvents, viscosity modifiers, adhesion promoters, ultra-violet absorbers, defoaming agents, dyes, or pigments. The amount of such additives may be determined by the end-use application.

In one embodiment, the solid insulating material is in contact with the high voltage secondary winding. In another embodiment, the solid insulating material is in contact with the primary windings. In one embodiment, the solid insulating material separates the low voltage primary windings and the high voltage secondary windings to the soft magnetic core. In yet another embodiment, the solid insulating material separates between the windings of the low voltage primary windings and the high voltage secondary windings.

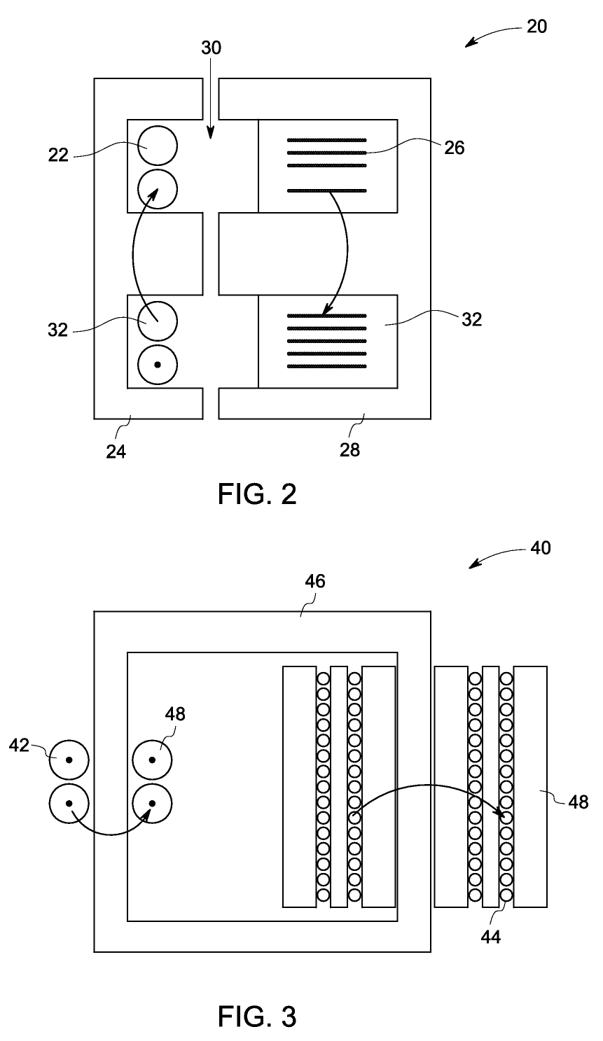

In one embodiment, as shown in FIG. 2 the transformer is a contactless transformer (20). The primary winding (22) is wound around a soft magnetic core (24), which has an E shape. The secondary winding (26) is wound about another soft magnetic core (28), which has an E shape that is separated from the soft magnetic core (24) by a thin air gap (30). The primary winding and the secondary winding are in contact with a solid insulating material comprising polydicyclopentadiene (32). In general, the length of the air gap is minimized in order to minimize the leakage inductance between the primary winding and the secondary winding. In one embodiment, the primary winding (22) is wound in one direction; the secondary winding (26) is likewise wound in opposite directions in the two secondary slots. In the E-shaped configuration of the primary winding and secondary winding each have a return path. The cross sectional E-core configuration is constructed by stacking commercially available E-core.

FIG. 3 shows another embodiment of the cross-section of conventional core type transformer (40). The primary winding (42) is wound about on one leg of the square or rectangular soft magnet core (46). The secondary winding (44) is wound about on the opposite leg of the same soft magnet core (46). The ratio of turns of the secondary winding and that of the primary winding is determined by the ratio of the desired output voltage and the input voltage. The high voltage side of the secondary winding layers are separated by the solid insulating material sheet (48) comprising polydicyclopentadiene with various thickness determined by the voltage needed to be isolated.

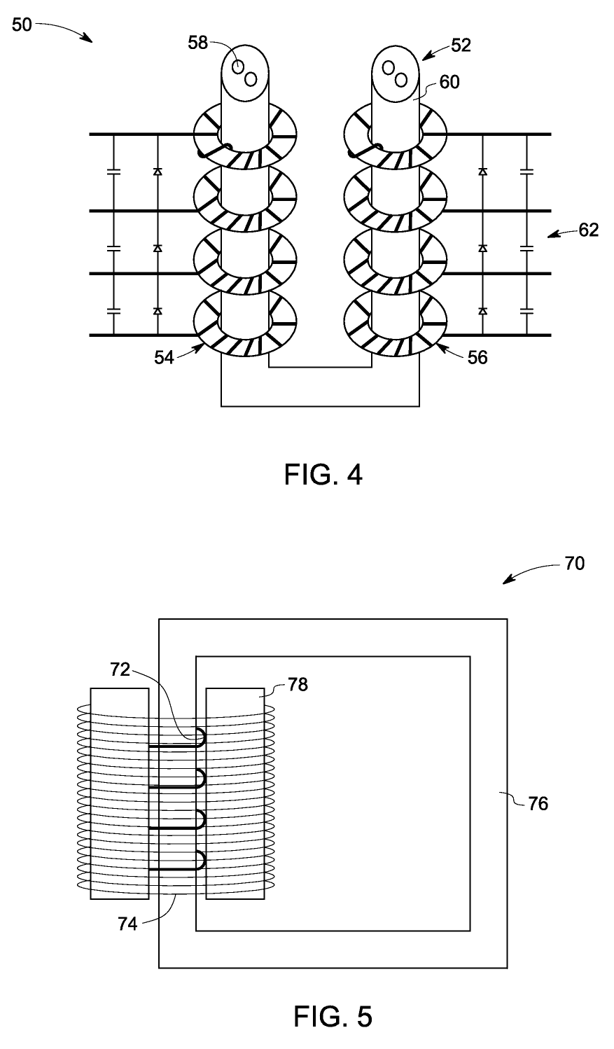

In one embodiment, the voltage transformer is a multicore type transformer (50) as shown in FIG. 4. The primary winding (52) is enclosed in a thick tube made of the solid insulating material (60), which separates the primary winding (52) and the secondary winding (54). The secondary windings are wound on multiple circular soft magnet cores (56). Each secondary winding is connected to a rectifier circuit (62) so that the AC voltage of the secondary winding is directly converted to DC voltage. The final DC voltage output is the sum of all the rectified DC voltages from the secondary winding voltages of the total number of cores. In one embodiment, the thickness of the solid insulating material comprising polydicyclopentadiene is determined by the maximum voltage difference between the primary winding and the secondary winding.

In one embodiment, the primary winding can include a first metal cylindrical wall having a longitudinal axis and a second metal wall surrounding the first metal wall. The second wall is a shield and has only continuously curved surfaces in proximity to the first wall. The first and second walls have adjacent ends that are electrically connected to each other so that they are at the same electric potential. In another embodiment, each of the secondary winding assemblies is magnetically coupled to the primary winding and has a different axial position relative to the length of the first wall and is in a volume between the first and second walls. Each of the assemblies includes a magnetic core having a circular inner diameter coaxial with the first wall and an outer diameter having only continuously curved surfaces. A winding is wound about each of the cores.

In one embodiment, a rectifier means connected to the winding of each of the assemblies develops a portion of the total high DC voltage produced by the supply. In one embodiment, to provide the spacing necessary for high voltage insulation the spacings from the inner wall to the inner diameter and from the outer diameter to the outer wall are such that the windings of the secondary assemblies are loosely coupled to the primary winding. The assemblies are connected together to add the developed voltages together to produce the high voltage. In one embodiment, a capacitor connected in series with the primary winding resonates the transformer with the source.

In one embodiment, the voltage transformer is a coaxial type transformer (70) as shown in FIG. 5. Both the primary winding (72) and the secondary winding (74) are wound about the same leg of the soft magnet core (76). The primary winding and the secondary winding are isolated by a thick tubular block of the solid insulating material (78) comprising polydicyclopentadiene. The thickness of the solid insulating material is determined by the maximum voltage difference between the primary and the secondary winding

In one embodiment, the insulating material comprising polydicyclopentadiene has an AC breakdown strength of at least about 40 kV/mm rms at 1 mm thickness in accordance with ASTM D149 method. In another embodiment, the insulating material comprising polydicyclopentadiene has an AC breakdown strength in a range from about 45 kV/mm rms to about 60 kV/mm rms at 1 mm thickness in accordance with ASTM D149 method. In one embodiment, the insulating material comprising polydicyclopentadiene has a DC breakdown strength of about 60 kV/mm at 5 mm thickness in accordance with ASTM D3755 method. In yet another embodiment, the insulating material comprising polydicyclopentadiene has a DC breakdown strength in a range from about 65 kV/mm to about 15 kV/mm at 5 mm thickness in accordance with ASTM D3755 method.

In one embodiment, the insulating material comprising polydicyclopentadiene has a dimension change of less than about 1% after being immersed in the transformer oil for about 5000 hours at a temperature of greater than about 100° C. In another embodiment, the insulating material comprising polydicyclopentadiene has a tensile modulus change of less than about 1% as measured in accordance with ASTM D3039 test method after being immersed in the transformer oil for about 5000 hours at a temperature of greater than about 100° C.

In one embodiment, the high voltage-high frequency electrical energy transformation apparatus is comprised within a CT scanner apparatus. In another embodiment, the high voltage-high frequency electrical energy transformation apparatus is comprised within a Mamography apparatus. In yet another embodiment, the high voltage-high frequency electrical energy transformation apparatus is comprised within a X-ray radiography apparatus.

In one embodiment, a CT scanner comprising a high voltage-high frequency electrical energy transformation apparatus, said apparatus comprising: (a) a frequency inverter capable of converting 60 Hz electrical energy into 40-600 KHz electrical energy; and (b) a voltage transformer. In one embodiment, the voltage transformer comprises an oil-filled transformer housing, at least one soft magnet core comprising a ferrite material; a low voltage primary winding; a high voltage secondary winding; and a solid insulating material comprising polydicyclopentadiene; wherein the solid insulating material is in contact with the high voltage secondary winding.

### EXAMPLES

### Method 1 Preparation of Dicyclopentadiene Containing 7-8% Oligomers

Dicyclopentadiene (4500 mL) was charged to a 5 L distillation flask equipped with a magnetic spin bar, a distillation head, a water chilled condenser, a nitrogen inlet, and a receiving flask. The dicyclopentadiene was purged with nitrogen for 30 min, and dicyclopentadiene was distilled under nitrogen at a distillation head temperature of about 135-1450° C. The distillate (about 4350 mL) obtained was mostly a mixture of cyclopentadiene monomer and cyclopentadiene dimer, with minor amounts of higher cyclopentadiene oligomers. The distillate was then heated to about 80° C. under nitrogen in a flask equipped with a magnetic stirrer, a water chilled condenser, and nitrogen inlet for about 1 hour until the cyclopentadiene reflux ceased. Thereafter, the distillate was heated to a maximum temperature of 180° C., and was refluxed under nitrogen for about 2 hours. Following the heating, the temperature was lowered to about 80° C. and maintained at that temperature for about 30 minutes until no further refluxing of cyclopentadiene was observed. The product dicyclopentadiene containing a controlled amount of cyclopentadiene oligomers was then cooled in an ice bath to about 1-2° C. and the nitrogen inlet was replaced with a vacuum line. The contents of the flask were then stirred vigorously at 0.5 Torr for about 2 hours. The resultant product dicyclopentadiene was analyzed for oligomer content as described below in the Oligomer Analysis section and was found to contain about 7-8% by weight cyclopentadiene oliomers. The product dicyclopentadiene was stored at less than about 5° C. until used.

### Oligomer Analysis

The dicyclopentadiene product prepared in Example 1 (50 grams) was placed into 250 ml round-bottom flask equipped with a magnetic stirrer and a vacuum outlet. Vacuum was applied to the flask, and volatiles were removed under reduced pressure at about 25° C. under vigorous stirring while periodically recording the weight of the flask and its contents. The flask was warmed under vacuum until a constant weight of the flask with remaining solid dicyclopentadiene oligomers was achieved. The weight percent of oligomers was calculated as 100×(weight of remaining solids)/50.

### Polymerization Studies

The effect of oligomer concentration on formulation fluidity and the properties of the product polymers were studied using dicyclopentadiene having varying amounts of oligomers present. About 0.75 g (0.5 weight percent) of triphenylphosphine was dissolved in 150 grams of DCPD in a 500 ml round bottom flask equipped with magnetic stirrer. The catalyst tricyclohexylphosphine[1,3-bis(2,4,6-trimethylphenyl)-4,5-dihydroimidazol-2-ylidene][(phenylthio)methylene]ruthenium(II)dichloride, (30 mg, 0.02 wt %) were dissolved in 0.4 ml of dry methylene chloride; 4.64 g of mineral oil (3 wt %) was added to the catalyst solution under vigorous magnetic stirring, and the mixture was vacuumed until bubbling ceased. The catalyst suspension in mineral oil was added to the monomer-triphenylphosphine mixture, and the flask was placed into an ice bath. The formulation was stirred under vacuum until the bubbles formation stopped. The flask was filled with nitrogen, was warmed to room temperature, and the formulation was transferred into molds to make objects of necessary shape. After 2 hrs of polymerization at room temperature, when the liquid formulation turned to a rubber like substance, the molds were placed into oven and were subjected to slow ramp heating to about 160° C., and then heated at about 160° C. for about 8 hrs. At the end of the stipulated time the molds were cooled by a slow ramp cooling to room temperature. The data is provided in Table 1.

TABLE 1

| | Wt % | | |
|---|---|---|---|
| Entry | oligomers | Formulation | Tg (° C.) |
| Comparative | 0.5 | solid at room | 136 |
| Example 1 | | temperature | |
| Comparative | 4 | Liquid, freezing | 95 |
| Example 2 | | point ~18° C. | |
| Example 1 | 7-8 | Liquid, freezing | 152 |
| | | point ~0° C. | |
| Example 2 | 15-20 | Liquid, freezing | 148 |
| | | point ~0° C. | |

### Sample Preparation For Hot Transformer Oil Stability Test

Triphenyl phosphine about 2.5 gram (0.5 wt. % relative to the monomer) was added to of liquid dicyclopentadiene about 500 g in a round bottom flask and was stirred magnetically until complete dissolution of the solids. The solution was then degassed under reduced pressure for 30 minutes to form a monomer-triphenylposphine mixture. About 0.100 g of the catalyst (0.02 wt. % relative to the monomer) was placed in a separate round bottom flask, followed by addition of 1 ml of dry methylene chloride. The mixture was stirred until complete solid dissolution. Following this about 15.46 g of mineral oil (3 wt. % of total oil+monomer) was added to the above catalyst solution under vigorous stirring, and the volatiles were removed under reduced pressure. The treated catalyst solution was added to the monomer-triphenylposphine mixture under vigorous stirring to form an activated mixture. The activated mixture was then poured into necessary molds. The mixture slowly solidified in about 1-2 hrs. The molds were placed in a programmable oven, and were heated up to about 160° C. for about 6 hrs. The molds were further heated at about 160° C. for about 16 hrs, and were then cooled to 30° C. in 2 hrs. At the end of the stipulated time the polydicyclopentadiene samples formed were removed from the molds, and were additionally heated in air at about 160° C. for about 8 hrs. If the polydicyclopentadiene samples needed to be machined, the machining was done prior to the second heating cycle.

The polydicyclopentadiene samples characteristics such as mass, linear dimensions, volume were measured. The polydicyclopentadiene samples were placed into glass jars filled with transformer oil. Each set included 10 specimens of polydicyclopentadiene samples. The jars with the polydicyclopentadiene samples were heated to about 130° C. in an oven, and the lids were closed. After measured time interval, the jars were cooled and the polydicyclopentadiene samples were cleaned with Kimwipe paper. The polydicyclopentadiene samples were then rinsed with copious amount of hexane and were dried. The sample characteristics were measured again and compared to the original ones. The change percent of a characteristic was calculated as the ratio of the difference between final and initial values to the initial values.

TABLE 2
Oil Stability Final Test at 130° C. (0.02 wt % ROMP catalyst,
3 wt % mineral oil, 0.5 wt % PPh)

| Hours in | | Strain | Modulus | Mass uptake | Length increase |
|---|---|---|---|---|---|
| Oil | UTS (psi) | @Failure (%) | (Kpsi) | (%) | (%) |
| | 7320 ± 131 | 3.33 ± 0.15 | 2.573 ± 0.265 | — | — |
| 160 | 6510 ± 327 | 2.75 ± 0.31 | 2.800 ± 0.195 | −0.024 ± 0.018 | −0.029 ± 0.094 |
| 379 | 6794 ± 153 | 3.33 ± 0.15 | 2.977 ± 0.505 | 0.088 ± 0.031 | 0.329 ± 0.052 |
| 500 | 6263 ± 318 | 2.89 ± 0.31 | 2.607 ± 0.385 | 0.112 ± 0.049 | 0.320 ± 0.076 |
| 750 | 6103 ± 232 | 2.68 ± 0.35 | 2.775 ± 0.352 | 0.185 ± 0.061 | 0.333 ± 0.080 |
| 1000 | 6475 ± 668 | 2.57 ± 0.26 | 2.946 ± 0.140 | 0.177 ± 0.092 | 0.295 ± 0.075 |

From Table 2 depicts the changes in the property of the example 1 when placed in oil at a temperature of about 130° C. for varying time intervals. It can be noticed that the oil uptake saturates at about 0.18 wt % after about 750 hrs and the dimensional increase is stable after about 380 hrs at 0.33% level

### Sample Preparation For Dielectric Breakdown Test

About 7.5 g of triphenyl phosphine (PPh₃) (0.5 wt. % relative to the monomer) was added to about 1500 g of liquid dicyclopentadiene in a round bottom flask. The mixture was magnetically stirred until there was complete dissolution of the solids. The round bottom flask was immersed into ice bath and was degassed under reduced pressure for about 30 min to form cold monomer-triphenylposphine mixture. About 0.300 g of the ring opening polymerization catalyst (0.02 wt. % relative to the monomer) was placed in a separate round bottom flask and about 2 ml of dry methylene chloride was added and stirred until the solid dissolved completely. About 46.38 g of mineral oil (3 wt. % of total oil+monomer) was added to the catalyst solution under vigorous stirring, and the volatiles were removed under reduced pressure. The catalyst solution was added to the cold monomer-triphenylposphine mixture under vigorous stirring conditions to form an activated mixture. The activated mixture was poured into necessary molds within about 10-15 min of activation.

### Formation Of Thick Sheets

The activated mixture formed by the above method was poured into rectangle molds composed of about 30 cm×30 cm glass sheets separated by a Pi-shaped Teflon spacer of necessary thickness. The molds were dried in an oven at about 90° C. for about 3 hrs and purged with dry nitrogen prior to the use.

The polymerization kinetics strongly depends on the mold thickness and temperature. In order to obtain objects with smooth, defect free surfaces, the polymerizations were run under conditions, which avoid strong exothermic effect. After the mixture has gelled or solidified at room temperature, the molds were placed in a programmable oven, heated up to about 160° C. for a period of about 6 hrs. The mixture was then kept at about 160° C. for about 16 hrs. After the stipulated time the mixture was cooled down to about 30° C. for about 2 hours. After removing from the polydicyclopentadiene samples from the molds, the polydicyclopentadiene samples were additionally heated in air at about 160° C. for about 8 hrs.

### Formation of Thin Sheets

The activated mixture formed by the method mentioned above was poured onto a 15 cm×15 cm square glass slide having about 0.04-0.1 mm thick shimming along the edges. Another glass slide was thoroughly placed on the top of the liquid to prevent trapping the air bubbles in the liquid. About 3 kg of flat metal weight was placed on the top of the glass sandwich until the mixture, which has flowed out of the sandwich, has gelled. The molds were placed in a programmable oven, were heated up to about 160° C. for about 6 hrs, and followed by keeping the molds at about 160° C. for about 16 hrs. This was followed by cooling the molds to about 30° C. for about 2 hrs. In order to remove the polymer films, the glass sandwiches were heated in a water bath at about 90° C. for about 2-3 hrs. The glass sandwiches were opened up with a razor blade. The polydicyclopentadiene films were rinsed with deionized water, were wiped with soft paper tissue, were then wiped with acetone, and were finally dried in vacuum oven at about 50-60° C. for about 3 hrs.

TABLE 3

| | | | CEx. 3 | CEx. 4 | |
|---|---|---|---|---|---|
| | | | Epoxy | Polyurethane | CEx. 5 |
| | Ex. 3 | Ex. 4 | (EPIC | (EPIC | RTV |
| | (PDCPD) | (PDCPD + 10% silica) | TC0118) | S7318) | silicone |
| Dielectric | 2.5 | 2.8 | 3.5 | 3.3 | 3.3 |
| constant | | | | | |
| (25 C., 1 kHz) | | | | | |
| Dielectric | 0.001 | 0.002 | 0.02 | 0.023 | 0.0055 |
| Loss (25 C., | | | | | |
| 1 kHz) | | | | | |
| AC | ~40 | ~40 | ~14 | ~17 | 19.7 |
| Breakdown | (2 mm) | (2 mm) | (3 mm) | (2.5 mm) | (1.9 mm) |
| strength, 60 Hz | | | | | |
| (kV/mm) | | | | | |
| Viscosity | ~5 | ~200 | ~5,000 | ~1,000 | ~9,900 |
| (cps, at 25 C.) | | | | | |
| Electrical | 10¹⁶ | 10¹⁵ | 10¹⁴ | 10¹² | 10¹⁵ |
| resistivity | | | | | |
| (ohm · cm) | | | | | |

From Table 3 it can be seen that the Example 3 comprising PDCPD has a low dielectric constant close to polypropylene and dielectric loss of 5-10 times lower than conventional thermosetting materials, such as epoxy (CEx.3), polyurethane (CEx.4) and silicone resin (CEx.5). It is also seen that the Ex. 3 has high DC and AC breakdown strength that is 2-3 times higher than conventional thermosetting materials of CEx.3-CEx.5. Moreover, PDCPD of Ex. 3 is found to have good thermal stability and mechanical strength. In addition due to the low viscosity of Ex.3 it can be used to filling in fine spaces and complicated geometries with minimal stress and few voids retention.

DC and AC breakdown tests provide short time failure conditions of samples under extreme electric stresses. At the breakdown value the stress level may sometimes be above its partial discharge inception value due to imperfection of the insulation materials. A partial discharge (PD) or corona (if PD is occurred on the surface) is a localized dielectric breakdown of a small portion of a solid or liquid electrical insulation system under high voltage stress. Partial discharge usually begins within voids, cracks, or inclusions within a solid dielectric. Partial discharge can cause progressive deterioration of insulating materials typically for polymeric insulations, ultimately leading to electrical breakdown. Addition of inorganic fillers, especially nano sized inorganic particles in to polymeric insulation can improves its partial discharge resistance. Corona resistance for Voltage endurance may be measured using the ASTM D2275-01 (2008)e1 method.

TABLE 4
Corona Resistance of PDCPD And PDCPD-Silica
Nanocomposite Films

| | Applied | | | | |
|---|---|---|---|---|---|
| | peak- | Applied | Corona | | |
| | to-peak | AC | inception | Film | Time to |
| | voltage | frequency | voltage | Thickness | Failure |
| | (kVpp) | (kHz) | (kVpp) | (mm) | (hrs.) |
| PDCPD (Ex. 3) | 2.58 | 1 | 1.29 | 0.044 | 2.6 |
| PDCPD + 2.5% | 1.64 | 1 | 0.82 | 0.028 | 30.83 |
| Silica (Ex. 5) | | | | | |
| PDCPD + 11% | 1.64 | 1 | 0.82 | 0.027 | 39.13 |
| Silica (Ex. 6) | | | | | |

Table 4 shows a comparison of PDCPD and PDCPD-silica nanocomposite films under the electric stress (58 kVpp/mm) that is well above the corona inception value at 1 kHz at an acclerated condition. It may be noticed that addition of about 2.5% by weight of nanosilica into PDCPD as in Ex. 5, the time to failure is increased by more than 6 times in comparisson to neat PDCPD (Ex.3). The resistance to corona was found improve with increasing amount of nanosilica. The tight pack of nanosilicas at the surface of the film may contribute to its great resistance of the surface corona around the electrode when about 2.5% silica is present (Ex.5).

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A high voltage-high frequency electrical energy transformation apparatus comprising:
(a) a frequency inverter capable of converting 60 Hz electrical energy into 40-100 KHz electrical energy; and
(b) a voltage transformer comprising
a transformer housing;
at least one soft magnetic core;
a low voltage primary winding and a high voltage secondary winding;
a solid insulating material comprising polydicyclopentadiene;
and wherein the solid insulating material is in contact with the high voltage secondary winding.

2. The apparatus according to claim 1, wherein the solid insulating material is in contact with the primary windings.

3. The apparatus according to claim 1, wherein the insulating material comprising polydicyclopentadiene is prepared by ring opening metathesis polymerization.

4. The apparatus according to claim 1, wherein the insulating material comprising polydicyclopentadiene is a cured resin.

5. The apparatus according to claim 4, wherein said cured resin is prepared from a polymerizable formulation comprising dicyclopentadiene and a ring opening metathesis polymerization catalyst.

6. The apparatus according to claim 5, wherein the catalyst is at least one selected from bis(tricyclohexylphosphine)benzylidine ruthenium (IV) chloride, 1,3-bis(2,4,6-trimethylphenyl)-2-imidazolidinylidene)dichloro(phenylmethylene) (tricyclohexylphosphine)ruthenium, 1,3-bis(2,4,6-trimethylphenyl)-2-imidazolidinylidene)dichloro(phenylmethylene) (di-3-bromopyridine)ruthenium, tricyclohexylphosphine[1,3-bis(2,4,6-trimethylphenyl)-4,5-dihydroimidazol-2-ylidene][(phenylthio)methylene]ruthenium(II)dichloride, or 1,3-bis-(2,4,6-trimethylphenyl)-2-imidazolidinylidene)dichloro(o-isopropoxyphenyl methylene)ruthenium.

7. The apparatus according to claim 1, wherein the insulating material further comprises nanoparticulate silica in an amount corresponding to from about 1 weight percent to about 20 weight percent based on the total weight of the solid insulating material.

8. The apparatus according to claim 1, wherein the insulating material comprising polydicyclopentadiene has an AC breakdown strength of at least about 40 kV/mm rms at 1 mm thickness in accordance with ASTM D149 method

9. The apparatus according to claim 1, wherein the insulating material comprising polydicyclopentadiene has a DC breakdown strength of about 60 kV/mm at 5 mm thickness in accordance with ASTM D3755 method.

10. The apparatus according to claim 1, wherein the insulating material comprising polydicyclopentadiene has a dimension change of less than about 1% in transformer oil for about 5000 hours at a temperature of greater than about 100° C.

11. The apparatus according to claim 1, wherein the insulating material comprising polydicyclopentadiene has a tensile modulus change of less than about 1% as measured in accordance with ASTM D3039 test method in transformer oil for about 5000 hours at a temperature of greater than about 100° C.

12. The apparatus according to claim 1, wherein the insulation material separates the low voltage primary windings and the high voltage secondary windings to the soft magnetic core.

13. The apparatus according to claim 1, wherein the insulation material separates between the windings of the low voltage primary windings and the high voltage secondary windings.

14. The apparatus according to claim 1, wherein the inverter is an IGBT based high frequency inverter.

15. A high voltage-high frequency electrical energy transformation apparatus comprising:
(a) a frequency inverter comprising an IGBT based high frequency inverter capable of converting 60 Hz electrical energy into 40-100 KHz electrical energy; and
(b) a voltage transformer comprising
a transformer housing;
at least one soft magnet core comprising a ferrite material;
a low voltage primary winding;
a high voltage secondary winding comprising a copper conductor;
a solid insulating material comprising polydicyclopentadiene;
and wherein the solid insulating material is in contact with the high voltage secondary winding.

16. The apparatus according to claim 15, which is comprised within a CT scanner apparatus.

17. The apparatus according to claim 15, which is comprised within a Mamography apparatus.

18. The apparatus according to claim 15, wherein the insulating material comprising polydicyclopentadiene is prepared by ring opening metathesis polymerization.

19. The apparatus according to claim 15, wherein the insulating material comprising polydicyclopentadiene is a cured resin.

20. The apparatus according to claim 19, wherein said cured resin is prepared from a polymerizable formulation comprising dicyclopentadiene and a ring opening metathesis polymerization catalyst.

21. The apparatus according to claim 19, wherein the insulating material further comprises nanoparticulate silica in an amount corresponding to from about 1 weight percent to about 20 weight percent based on the total weight of the solid insulating material.

21. The apparatus according to claim 15, wherein the insulating material comprising polydicyclopentadiene has a dimension change of less than about 1% in transformer oil for about 5000 hours at a temperature of greater than about 100° C.

22. The apparatus according to claim 15, wherein the insulating material comprising polydicyclopentadiene has a tensile modulus change of less than about 1% as measured in accordance with ASTM D3039 test method in transformer oil for about 5000 hours at a temperature of greater than about 100° C.

23. A CT scanner comprising a high voltage-high frequency electrical energy transformation apparatus, said apparatus comprising:
(a) a frequency inverter capable of converting 60 Hz electrical energy into 40-600 KHz electrical energy; and
(b) a voltage transformer comprising
an oil-filled transformer housing,
at least one soft magnet core comprising a ferrite material;
a low voltage primary winding;
a high voltage secondary winding;
a solid insulating material comprising polydicyclopentadiene;
and wherein the solid insulating material is in contact with the high voltage secondary winding.
